(19) United States
(12) Patent Application Publication
(10) Pub. No.: US 2015/0087891 A1
(43) Pub. Date: Mar. 26, 2015

(54) Osteoconductive Implantable Component for a Bone Conduction Device

(71) Applicants: Goran Bjorn, Onsala (SE); Jerry Frimanson, Onsala (SE)

(72) Inventors: Goran Bjorn, Onsala (SE); Jerry Frimanson, Onsala (SE)

(21) Appl. No.: 14/032,247

(22) Filed: Sep. 20, 2013

(51) Int. Cl. H04R 25/00

(52) U.S. Cl. CPC H04R 25/65
USPC 600/25

(57) ABSTRACT

An osteoconductive implantable component for use in coupling a bone conduction device to a recipient is provided. The implantable component is configured to be implanted adjacent to a recipient's bone and is configured to promote bone ingrowth and/or ongrowth to interlock the implantable component with the recipient's bone so as to prevent movement of the implantable component with respect to the recipient's skull.

### BACKGROUND

1. Field of the Invention

The present invention relates generally to an implantable component for use with a bone conduction device, and more particularly, to an osteoconductive implantable component for a bone conduction device.

2. Related Art

Hearing loss, which may be due to many different causes, is generally of two types, conductive and/or sensorineural. Conductive hearing loss occurs when the normal mechanical pathways of the outer and/or middle ear are impeded, for example, by damage to the ossicular chain or ear canal. Sensorineural hearing loss occurs when there is damage to the inner ear, or to the nerve pathways from the inner ear to the brain.

Individuals suffering from conductive hearing loss typically receive an acoustic hearing aid. Hearing aids rely on principles of air conduction to transmit acoustic signals to the cochlea. Typically, a hearing aid is positioned in the ear canal or on the outer ear to amplify received sound. This amplified sound is delivered to the cochlea through the normal middle ear mechanisms resulting in the increased perception of sound by the recipient.

In contrast to acoustic hearing aids, certain types of auditory prostheses, commonly referred to as bone conduction devices, convert a received sound into vibrations. The vibrations are transferred through teeth and/or bone to the cochlea, causing generation of nerve impulses, which result in the perception of the received sound. Bone conduction devices are suitable to treat a variety of types of hearing loss and may be suitable for individuals who cannot derive sufficient benefit from acoustic hearing aids, cochlear implants, etc., or for individuals who suffer from stuttering problems.

### SUMMARY

In one aspect of the invention, an implantable component configured to couple an external bone conduction device to a recipient is provided. The implantable component comprises an osteoconductive body comprising a first surface configured to be positioned substantially parallel to and abutting a surface of the recipient's skull, a second surface opposing the first surface, and a lateral surface connecting the first and second surfaces, wherein the body is a porous-solid scaffold configured to promote growth of the recipient's skull bone in a manner that interlocks the osteoconductive body with the recipient's skull.

In another aspect of the present invention, an implantable component configured to couple an external element to a recipient is provided. The implantable component comprises a body comprising a first surface configured to be positioned substantially parallel to and abutting a surface of the recipient's skull, a second surface opposing the first surface, and a lateral surface connecting the first and second surfaces, and a plurality of features configured to promote bone growth from the surface of the recipient's skull in a manner such that the bone growth interlocks with the plurality features so as to prevent movement of the implantable component with respect to the recipient's skull.

### BRIEF DESCRIPTION OF THE DRAWINGS

Embodiments of the present invention are described herein in conjunction with the accompanying drawings, in which:

FIG. 1 is a cross-sectional schematic diagram of an osteoconductive implantable component in accordance with embodiments presented herein configured for use with a percutaneous bone conduction device;

FIG. 2 is a cross-sectional schematic of an osteoconductive implantable component in accordance with embodiments presented herein configured for use with a transcutaneous bone conduction device;

FIG. 3A is a lower-perspective view of an osteoconductive implantable component in accordance with embodiments presented herein;

FIG. 3B is a upper-perspective view of the osteoconductive implantable component of FIG. 3A;

FIG. 3C is a cross-sectional view of the osteoconductive implantable component of FIG. 3A;

FIG. 4 is a side view of an osteoconductive implantable component in accordance with embodiments presented herein secured to a recipient with a bonding agent;

FIG. 5A is a upper-perspective view of an osteoconductive implantable component in accordance with embodiments presented herein;

FIG. 5B is a cross-sectional view of the osteoconductive implantable component of FIG. 5A;

FIG. 6A is an upper-perspective view of an osteoconductive implantable component in accordance with embodiments presented herein;

FIG. 6B is a cross-sectional view of the osteoconductive implantable component of FIG. 6A;

FIG. 7 is a cross-sectional view of an osteoconductive implantable component in accordance with embodiments presented herein;

FIG. 8 is an enlarged view of a portion of an osteoconductive implantable component in accordance with embodiments presented herein;

FIG. 9A is a side view of an osteoconductive implantable component in accordance with embodiments presented herein secured to a recipient with a bonding agent;

FIG. 9B is a lower-perspective view of the osteoconductive implantable component of FIG. 9A;

FIG. 10A is a lower-perspective view of an osteoconductive implantable component in accordance with embodiments presented herein;

FIG. 10B is a bottom view of an osteoconductive implantable component in accordance with embodiments presented herein;

FIG. 11A is a bottom view of an osteoconductive implantable component in accordance with embodiments presented herein;

FIG. 11B is a bottom view of an osteoconductive implantable component in accordance with embodiments presented herein; and

FIG. 12 is a side view of an osteoconductive implantable component in accordance with embodiments presented herein.

### DETAILED DESCRIPTION

In certain circumstances, a bone conduction device may be coupled to a recipient using a percutaneous solution wherein a percutaneous abutment extends from an implantable component attached to the recipient's skull bone via one or more bone screws. The percutaneous bone conduction device mechanically attaches to a portion of the abutment that is disposed outside of the recipient's skin. In other circumstances, a bone conduction device may be coupled to a recipient using a variety of transcutaneous solutions. For example, a transcutaneous bone conduction (or a portion thereof) may include a magnetic plate that magnetically couples to a magnetic implantable component attached to a recipient's skull via one or more bone screws. Transcutaneous bone conduction devices may include active or passive implant components.

A wide range of individuals may be candidates for bone conduction devices. In certain circumstances, individuals may have skull bones that are thinner than the skull bone of an average bone conduction recipient. The thinness of the skull may be due to, for example, age (i.e., young children naturally have thinner skull bones that adults) or as a result of trauma or a medical condition (e.g., cancer, etc.). In certain individuals, the skull bone may be also or alternatively compromised as a result of trauma or medical condition. Thin or compromised skull bones may affect the ability to attach an implantable component to a recipient's skull, thereby limiting the candidates who may receive certain bone conduction devices.

Embodiments of the present invention are generally directed to an osteoconductive implantable component for use in coupling a bone conduction device to a recipient. The implantable component is configured to be implanted adjacent to a recipient's bone and is configured to promote bone ingrowth and/or ongrowth to interlock the implantable component with the recipient's bone so as to prevent movement of the implantable component with respect to the recipient's skull. In certain circumstances, the osteoconductive implantable component eliminates the need for bone screws and/or enables use shorter bone screws (relative to traditional arrangements) so as to be suitable for use in individuals with thin or compromised skull bones.

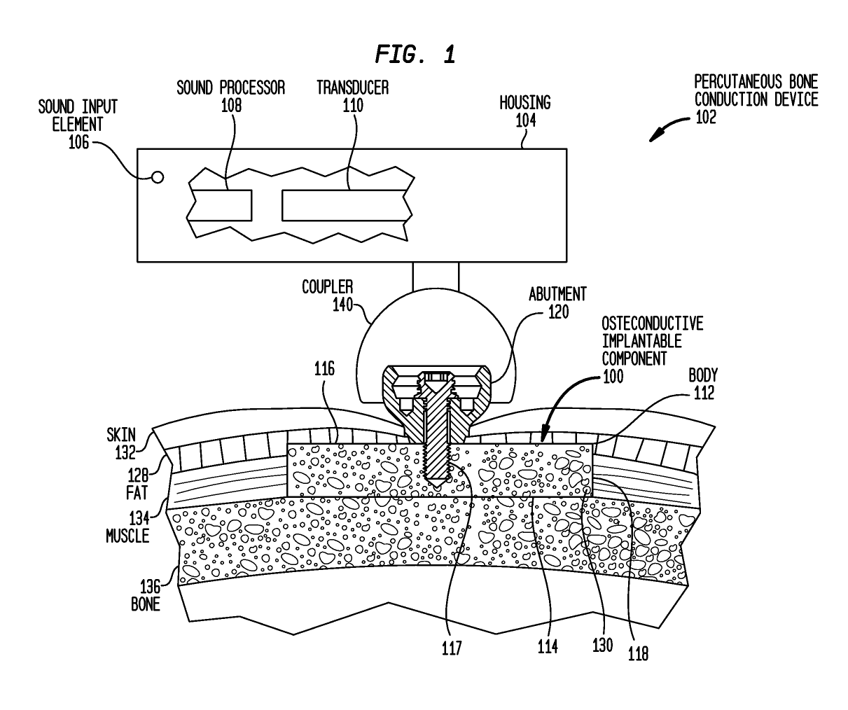

FIG. 1 is a cross-sectional view of an osteoconductive implantable component 100 in accordance with embodiments presented herein. The osteoconductive implantable component 100 is configured to couple a percutaneous bone conduction device 102 to a recipient.

The percutaneous bone conduction device 102 comprises a housing 104 and a sound input element 106. The sound input element 106 may be, for example, a microphone, telecoil or similar device configured to receive (detect) sounds. In the present example, sound input element 106 is located on housing 104, but may alternatively be positioned on a cable extending from bone conduction, positioned in a recipient's ear, subcutaneously implanted in the recipient, etc. Sound input element 106 may also be a component that receives an electronic signal indicative of sound, such as, for example, from an external audio device. For example, sound input element 106 may receive a sound signal in the form of an electrical signal from a device electronically connected to sound input element 106. Additionally, multiple sound input elements 106 may be provided.

Bone conduction device 102 comprises a sound processor 108, a transducer (actuator) 110, and/or various other operational components (not shown in FIG. 1) all disposed in housing 104. A portion of the housing 104 has been omitted from FIG. 1 to illustrate portions of the sound processor 108 and the transducer 110.

In operation, sound input element 106 converts received sound signals into electrical signals. These electrical signals are processed by the sound processor 108 to generate control signals that cause vibration of transducer 110. In other words, the transducer 110 converts the electrical signals received from the sound processor 108 into mechanical vibrations. The transducer 110 may be, for example, an electromagnetic transducer, piezoelectric transducer, etc.

As shown, the osteoconductive implantable component 100 comprises a body 112 that primarily has an osteoconductive structure. As used herein, an osteoconductive structure is a structure that promotes the growth of a recipient's bony tissue into the structure, referred to as bone ingrowth, so as to interlock the structure with the bony tissue. In addition to bone ingrowth, an osteoconductive structure may also be configured to promote bone ongrowth. In the specific embodiment of FIG. 1, the osteoconductive body 112 is a porous mesh or scaffold that allows for vascular and cellular migration, attachment, and distribution through the exterior pores.

FIG. 1 illustrates an example in which the osteoconductive body 112 has a plurality of pores 130 and a generally trabecular (bone-like) structure. That is, body 112 is a porous-solid scaffold comprising an irregular three-dimensional array of struts. The term “strut” refers to the structural members (e.g., rods, beams, plates, shells columns, etc.) within a porous-solid material. In other words, the term strut is a general term to refer to the actual material elements (i.e., non-air portions) that form the porous-solid body. The array of struts is considered to be “irregular” because the struts and pores 130 are not arranged in any systematic manner.

The body 112 has a first surface 114 that is configured to be positioned abutting the recipient's skull bone and a second surface 116 substantially parallel to the first surface 114. The first surface 114 is separated from the second surface by a lateral surface 118. A threaded aperture 117 extends from the first surface 114 into the body 112. The threaded aperture 117 is configured to receive a threaded abutment 120. The body 112 is positioned below the recipient's skin 132 (e.g., adjacent to fat 128 and/or muscle 134). However, the abutment 120 extends from the body 112 through the skin 132. That is, the abutment 120 is a percutaneous element.

Bone conduction device 102 further includes coupling apparatus (coupler) 140 that is configured to attach to the exposed portion of abutment 120 (i.e., the portion outside of the skin 132). The mechanical force generated by the transducer 110 is transferred through the coupler 140, abutment 120, and the osteoconductive implantable component 100 to effect vibration of the recipient's skull bone 136 and eventual movement of fluid within the recipient's cochlea, thereby causing a hearing sensation. As such, the osteoconductive implantable component 100 interlocks so as to be substantially rigidly attached to the recipient's skull bone 136 and to prevent movement of the implantable component 100 with respect to the recipient's skull 136. This rigid attachment enables the implantable component 100 to support bone conduction device 100 (when attached to the abutment 120) and enables the transfer of the vibrations from the abutment 120 to the skull bone 136.

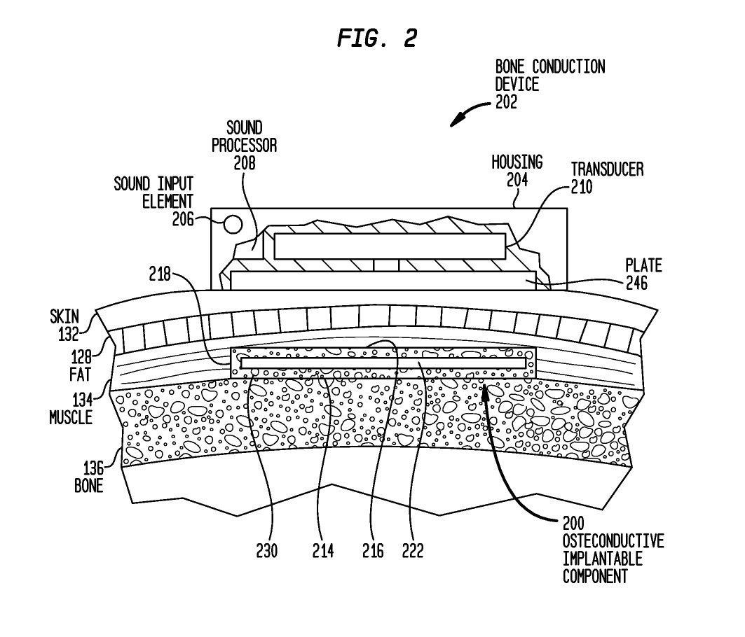

FIG. 2 is a cross-sectional view of another osteoconductive implantable component 200 configured to couple a transcutaneous bone conduction device 202 to a recipient. Similar to the embodiment of FIG. 1, the transcutaneous bone conduction device 202 comprises a housing 204 and a sound input element 206. In the present example, sound input element 206 is located on housing 204.

Bone conduction device 202 comprises a sound processor 208, a transducer (actuator) 210, an external plate 246, and/or various other operational components (not shown in FIG. 2) all disposed in housing 204. A portion of the housing 204 has been omitted from FIG. 2 to illustrate portions of the sound processor 208, the transducer, and the plate 246.

As shown, the osteoconductive implantable component 202 comprises a body 212 that primarily has an osteoconductive structure. Similar to the embodiments of FIG. 1, the body 212 is porous-solid scaffold comprising an irregular three-dimensional array of struts that allows for vascular and cellular migration, attachment, and distribution through the exterior pores 230. The body 212 has a first surface 214 that is configured to be positioned abutting the recipient's skull bone and a second surface 216 substantially parallel to the first surface 214. The second surface 216 is separated from the first surface by a lateral surface 218. The body 212 is positioned below the recipient's skin 132 (e.g., adjacent to fat 128 and/or muscle 134). Disposed in the body 212 between the first surface 214 and the second surface 216 is an implantable plate 222. Implantable plate 222 may be a permanent magnet or include magnetic material that generates and/or is reactive to a magnetic field.

External plate 246 disposed in bone conduction device 202 may be in the form of a permanent magnet and/or in another form that generates and/or is reactive to a magnetic field. More specifically, the external plate 246 is configured to generate or otherwise establish a magnetic attraction with the implantable plate 222 that is sufficient to hold the bone conduction device 202 against the skin 132 of the recipient.

In accordance with certain embodiments presented herein, the implantable plate 222 may disposed at the top surface 216 of the body 212. Additionally or alternatively, the osteoconductive features (e.g., pores 230) may be disposed at the top surface 216 of the body 212.

In operation, sound input element 206 converts received sound signals into electrical signals. These electrical signals are processed by the sound processor 208 to generate control signals that cause vibration of transducer 210. In other words, the transducer 210 converts the electrical signals received from the sound processor 208 into mechanical vibrations. The transducer 210 is mechanical coupled to the external plate 246, while the external plate 246 is magnetically coupled to the implantable plate 222. As such, the vibrations generated by transducer 210 are transferred from the transducer 210 to the external plate 246 and then are transcutaneously transferred across the skin 132 to the implantable plate 222. The transcutaneous transfer may be accomplished as a result of mechanical conduction of the vibrations through the skin 132, resulting from the bone conduction device 202 being in direct contact with the skin, and/or from the magnetic field between the external plate 246 and the implantable plate 222. As such, these vibrations are transferred without penetrating the skin with a solid object such as an abutment as detailed above with respect to a percutaneous bone conduction device.

In the embodiment of FIG. 2, the osteoconductive implantable component 200 interlocks with the recipient's bone (via ingrowth and/or ongrowth) so as to be substantially rigidly attached to the recipient's skull bone 136 and to prevent movement of the implantable component 200 with respect to the recipient's skull 136. This rigid attachment enables the implantable component 200 to support bone conduction device 100 (when magnetically attached) and enables the transfer of the vibrations to the skull bone 136.

As described above with reference to FIGS. 1 and 2, embodiments presented herein are directed to osteoconductive implantable components for use with percutaneous or transcutaneous bone conduction devices. In general, osteoconductive implantable components for use with percutaneous bone conduction devices include a threaded aperture or other mechanism for attachment to a percutaneous abutment. Osteoconductive implantable components for use with transcutaneous bone conduction devices generally include a magnetic implantable plate for magnetic coupling to an external magnetic plate. Merely for ease of illustration, embodiments of the present invention will be primarily described with reference to osteoconductive implantable components having a threaded aperture for use with a percutaneous abutment. It is to be appreciated that the various embodiments presented herein may be modified for use in different percutaneous arrangements (i.e., different abutment attachment mechanisms) or in transcutaneous arrangements (i.e., to include an implantable magnetic plate for coupling to an external magnetic plate).

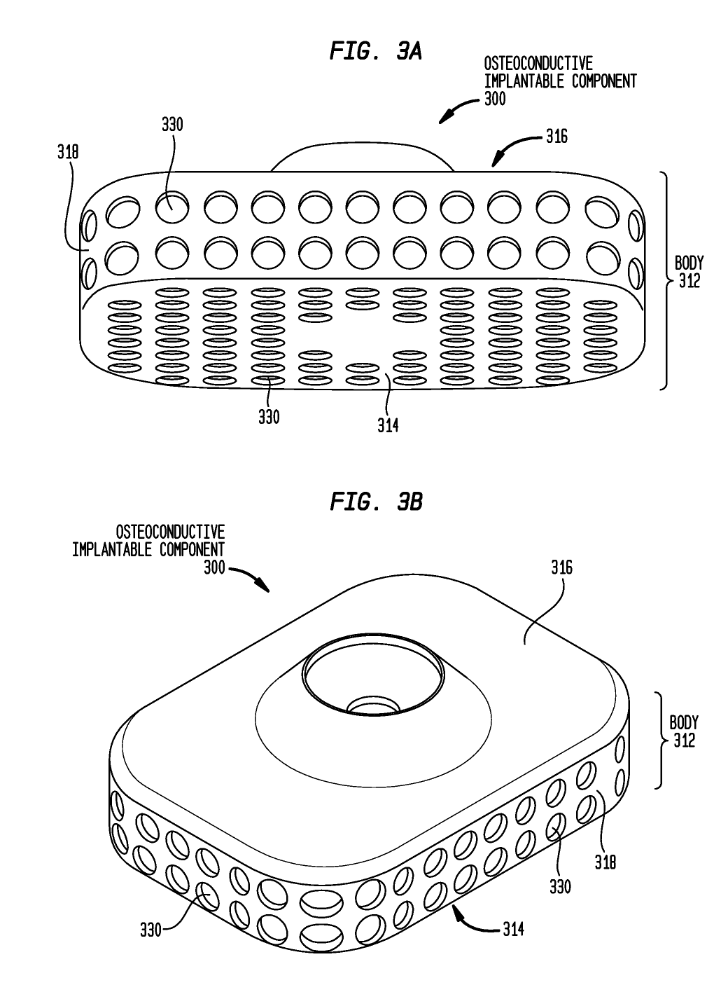

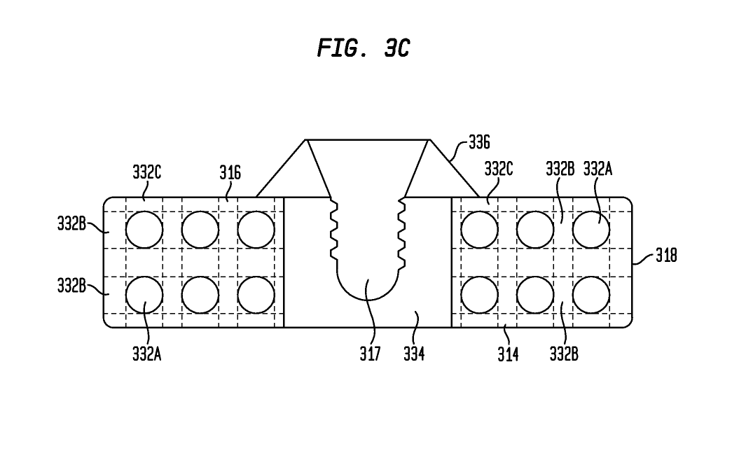

FIGS. 3A and 3B are lower-perspective and upper-perspective views, respectively, of an osteoconductive implantable component 300 in accordance with embodiments presented herein. FIG. 3C is a cross-sectional view of the osteoconductive implantable component 300.

As shown, the osteoconductive implantable component 300 comprises a body 312 formed by a first (bottom) surface 314, a second (top) surface 316, and a lateral (side) surface 318 connecting the bottom surface 314 to the top surface 316. As used herein, a “bottom” surface refers to a surface of an implantable component that is configured to be implanted facing a recipient's skull bone, while a “top” surface refers to a surface configured to be implanted facing a recipient's skin.

The body 312 of FIGS. 3A and 3B has a generally rectangular shape where the lateral surface 318 generally has four sides connected by rounded corners. The generally rectangular shape of body 312 is merely illustrative and other shapes are possible. For example, in alternative embodiments the body 312 may have a flat-circular (disc) shape.

Returning to the embodiments of FIGS. 3A-3C, each of the lateral surface 318 and the bottom surface 314 has a plurality of apertures or pores 330 disposed therein. The pores 330 are the inlets for channels/tunnels 332A, 332B, and 332C (FIG. 3C) that extend (partially or fully) through the main portion of body. As such, the body 312 is a porous-solid scaffold comprising a regular three-dimensional array of struts. The array of struts is considered to “regular” because the struts, pores 330, and channels 332A, 332B, and 332C, are arranged in a systematic manner (i.e., an organized structure).

Reference numbers 332A in FIG. 3C refer to channels that extend through the body 312 between surfaces of the lateral surface 318 in a first direction and are referred to as transverse channels. Reference numbers 332B refer to channels that extend through the body 312 between surfaces of the lateral surface 318 in a second direction that is substantially orthogonal to the first direction. For ease of illustration, the channels 332B are shown using dashed lines and are referred to as longitudinal channels 332B. Additionally, reference numbers 332C refer to channels that extend from the bottom surface 314 through a portion of the body 312 in a directional that is orthogonal to both the transverse channels 332A and the longitudinal channels 332B. This third set of channels 332C are sometimes referred to herein as vertical channels 332C.

In the mesh structure of FIGS. 3A-3C, certain transverse channels 332A intersect with certain longitudinal channels 332B and vertical channels 332C. In alternative embodiments, the transverse channels 332A, longitudinal channels 332B, and vertical channels 332C may be configured such that channels do not intersect one another. It is to be appreciated that these arrangements of channels 332A, 332B, and 332C are merely illustrative and that other arrangements are possible. For example, in certain embodiments, the osteoconductive features (e.g., pores 330) may be disposed at the top surface 316 of the body 212.

The body 312 includes a substantially solid central region 334 (i.e., a region that does not include any channels 332A, 332B, or 332C). Extending from top surface 316 into this central region 334 is a threaded aperture 317 that is configured to receive and mate with a threaded abutment. Integrated with surface 316 above the central region 334 is a generally frustoconical member 336 having an opening 338 therein in which a portion of a threaded abutment may be disposed.

The body 312 may be made from, for example, titanium or a titanium alloy. In certain embodiments, the pores 330 may have diameters in the arrange of approximately 0.2 millimeters (mm) to approximately 0.8 mm and the supporting titanium structure (i.e., struts) may have a thickness between approximately 0.1 mm to approximately 0.9 mm. The pores 330 and channels 332A, 332B, or 332C may be formed by, for example, milling, drilling, turning, Electro Beam Melting, laser processing, or a similar production process.

In certain embodiments, one or more surfaces 314, 316, and/or 318 of body 312 may have a surface roughness configured to further promote bone ongrowth. For example, the surfaces of body 314, 316, and/or 318 may have a medium arithmetic roughness (Ra) between approximately 0.9 μm to approximately 2 μm. The surfaces 314, 316, and/or 318 can also have a course Ra from approximately 1.6 μm to approximately 25 μm. The surfaces 314, 316, and/or 318 may be roughened via grit blasting, plasma-spraying, acid etching, laser modified, combinations thereof, or similar processes.

In the embodiments of FIGS. 3A-3C, the osteoconductive implantable component 300 is attached to the bone through the bone ingrowth and/or bone ongrowth promoted by the structure of body 312. In general, the porous-solid structure of body 312 allows for vascular and cellular migration, attachment, and distribution through the exterior pores 330 into the body 312, thereby interlocking the osteoconductive implantable component 300 with the recipient's skull bone. This interlocking provides for long-term, substantially rigid attachment to the recipient's skull bone that is sufficient to support a bone conduction device and to transfer vibration received from the bone conduction device to the recipient's skull bone.

Sufficient osteoconduction to interlock the osteoconductive implantable component 300 with the recipient's skull bone to support a bone conduction device and to transfer vibration may take some time after the initial surgery (e.g., several weeks or months). In certain embodiments, the recipient's tissue (e.g., skin, fat, and/or muscle) retains the osteoconductive implantable component 300 in position relative to the skull bone to enable the osteoconduction. However, in accordance with certain embodiments presented herein, a secondary attachment mechanism may be provided to retain the osteoconductive implantable component 300 in position relative to the skull bone to facilitate the osteoconduction.

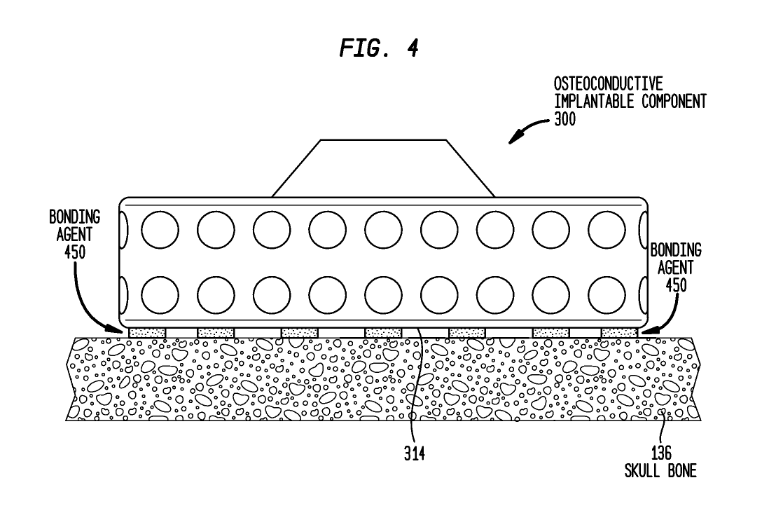

For example, FIG. 4 is a side view of an embodiment in which a bonding agent 450 is used to initially secure osteoconductive implantable component 300 to a recipient's skull bone 136. In the embodiment of FIG. 4, the bonding agent 450 is disposed on the bottom surface 314 between the pores 330. That is, the bonding agent 450 is disposed on the surface such that it does not interfere with the osteoconduction. In certain embodiments, the bonding agent 450 is bone cement. The bone cement may be, for example, ionomeric bone cement or poly methyl methacrylate (PMMA) bone cement. In other embodiments, the bonding agent 450 may be any biocompatible adhesive now known or later developed. In certain embodiments, the bonding agent 450 may be configured to be resorbed by the recipient's bone after fibrotic encapsulation that may occur during osteoconduction.

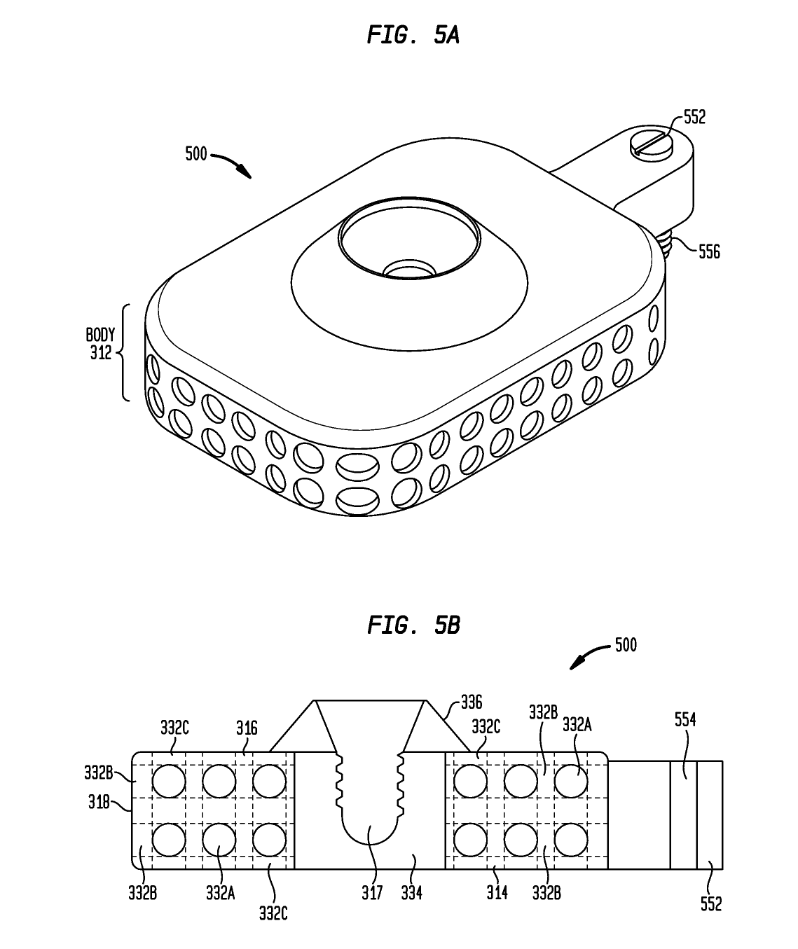

FIGS. 5A and 5B are perspective and cross-sectional views, respectively, of an osteoconductive implantable component 500 that is similar to the osteoconductive implantable component 300 of FIGS. 3A-3C. In particular, the osteoconductive implantable component 500 comprises a body 312 formed by a bottom surface 314, a top surface 316, and a lateral surface 318 connecting the bottom surface 314 to the top surface 316. The lateral surface 318 and the bottom surface 314 have a plurality of pores 330 disposed therein that form inlets of channels/tunnels 33A, 332B, and 332C that extend (partially or fully) through the main portion of body 312. In other words, the body 312 is a porous-solid scaffold.

In the embodiment of FIGS. 5A and 5B, the osteoconductive implantable component 500 also comprises an attachment member 552 extending from a surface of lateral surface 318. As shown, the attachment member 552 includes an aperture (through-hole) 554 that extends there through. The aperture 554 is configured such that a bone screw 556 may be inserted therein to secure the osteoconductive implantable component 500 to the recipient's skull bone during osteoconduction. For ease of illustration, the bone screw 556 has been omitted from FIG. 5B.

As noted above, the porous-solid structure of body 312 allows for vascular and cellular migration, attachment, and distribution through the exterior pores 330 into the body 312, thereby interlocking the osteoconductive implantable component 300 with the recipient's skull bone. This interlocking provides for long-term, substantially rigid attachment to the recipient's skull bone that is sufficient to support a bone conduction device and to transfer vibration received from the bone conduction device to the recipient's skull bone. The bone screw 556 is only used to retain the osteoconductive implantable component 500 in position during osteoconduction, but is not required to secure the osteoconductive implantable component 500 when supporting a bone conduction device. As such, the bone screw 556 may be shorter than bone screws used in conventional arrangements and, accordingly, may be used in recipient's having thin or compromised skull bones. In certain examples, the bone screw 556 may extend in a recipient's skull less than 2 mm

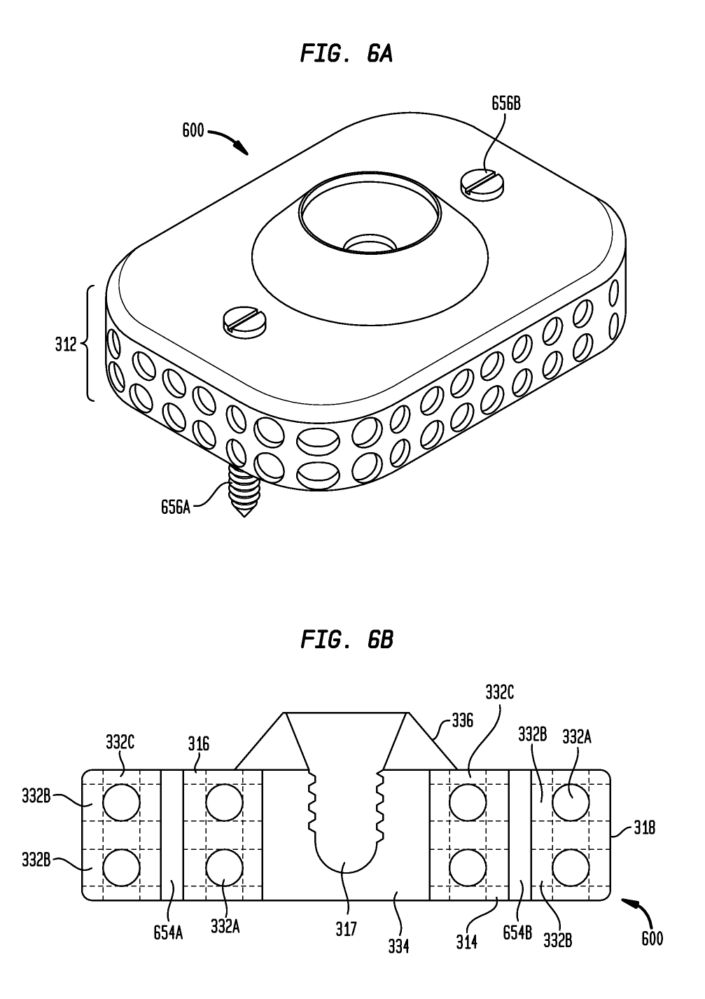

FIGS. 6A and 6B are perspective and cross-sectional views, respectively, of an osteoconductive implantable component 600 that is similar to the osteoconductive implantable component 300 of FIGS. 3A-3C. In particular, the osteoconductive implantable component 600 comprises a body 312 formed by a bottom surface 314, a top surface 316, and a lateral surface 318 connecting the bottom surface 314 to the top surface 316. The lateral surface 318 and the bottom surface 314 have a plurality of pores 330 disposed therein that form inlets of channels/tunnels 332A, 332B, and 332C that extend (partially or fully) through the main portion of body 312. In other words, the body 312 is a porous-solid scaffold.

In the embodiment of FIGS. 6A and 6B, the osteoconductive implantable component 600 also comprises two apertures (through-holes) 654A and 654B extending from the top surface 316 to bottom surface 314 (i.e., extending through the body 312). The apertures 654A and 654B are configured such that bone screws 656A and 656B may be inserted in to the apertures 654A and 654B, respectively, to secure the osteoconductive implantable component 600 to the recipient's skull bone during osteoconduction. For ease of illustration, the bone screws 656A and 656B have been omitted from FIG. 6B.

As noted above, the porous-solid structure of body 312 allows for vascular and cellular migration, attachment, and distribution through the exterior pores 330 into the body 312, thereby interlocking the osteoconductive implantable component 600 with the recipient's skull bone. This interlocking provides for long-term, substantially rigid attachment to the recipient's skull bone that is sufficient to support a bone conduction device and to transfer vibration received from the bone conduction device to the recipient's skull bone. The bone screws 656A and 656B may only be used to retain the osteoconductive implantable component 600 in position during osteoconduction and/or to secure the osteoconductive implantable component 600 when supporting a bone conduction device. Due to the osseoconductive nature of the implantable component 600, the bone screws 656A and 656B may be shorter than bone screws used in conventional arrangements and, accordingly, may be used in recipient's having thin or compromised skull bones. In certain examples, the bone screws 656A and 656B may each extend in a recipient's skull less than 2 mm

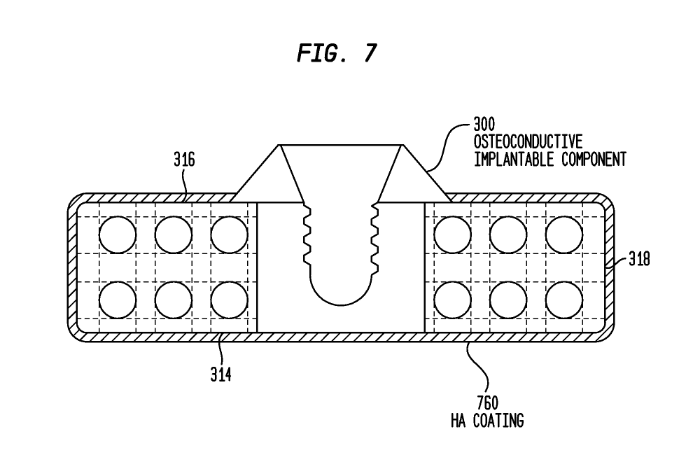

FIG. 7 is a cross-sectional view of osteoconductive implantable component 300 in an embodiment in which a coating or surface treatment 760 is applied to the osteoconductive implantable component 300. The surface treatment 760 is configured to provide the osteoconductive implantable component 300 with a modified surface that promotes faster and stronger bone formation, better stability during the healing process and improved performance in circumstances with poor bone quality and quantity. In one specific such example, the surface treatment 760 to is a Hydroxyapatite (HA) or similar coating 760 with a thickness in range of approximately 5 nanometers (nm) to approximately 20 μm. In certain embodiments the HA coating may be resorbable.

In further embodiments, the surface treatment 760 is an osteoinductive biomaterial that is configured to actively stimulate new bone growth. In one such embodiment, the osteoinductive surface treatment 760 comprises bone morphogenetic proteins (BMPs). An implantable component that is osteoconductive (provided by body 312) and osteoinductive (provided by surface treatment 760) may serve as a scaffold for currently existing osteoblasts, but may also trigger the formation of new osteoblasts, promoting faster integration of the implantable component 300 with the recipient's skull bone.

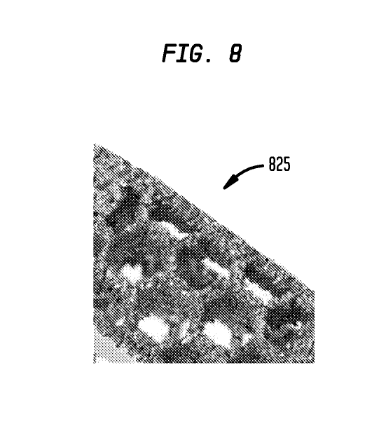

FIGS. 3A-7 illustrate embodiments in which the bodies of osteoconductive implantable component have a regular three-dimensional array of struts. That is, the pores and channels in FIGS. 3A-7 are arranged in a systematic manner. FIG. 8 illustrates an alternative embodiment in which an implantable component has a trabecular (bone-like) structure. More specifically, FIG. 8 illustrates an enlarged view of a portion 825 of a body of an implantable component configured to be implanted adjacent to a recipient's bone and is configured to promote bone ingrowth and/or ongrowth to interlock the implantable component with the recipient's bone. In the embodiments of FIG. 8, the portion 825, as well as the remainder of the osteoconductive implantable component, is a porous-solid scaffold that comprises an irregular three-dimensional array of struts. Similar to the above embodiments, the irregular scaffold of FIG. 8 allows for vascular and cellular migration, attachment, and distribution through the exterior pores into the scaffold. The porous solid scaffold FIG. 8 may be formed, for example, from a solid titanium structure by chemical etching, photochemical blanking, electroforming, stamping, plasma etching, ultrasonic machining, water jet cutting, electrical discharge machining, electron beam machining, or similar process.

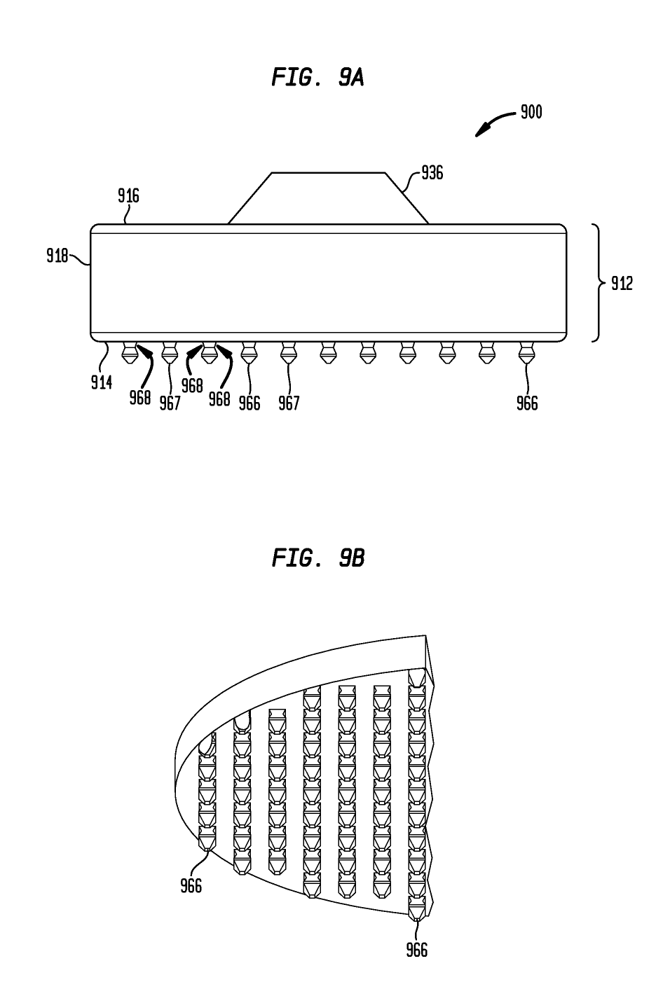

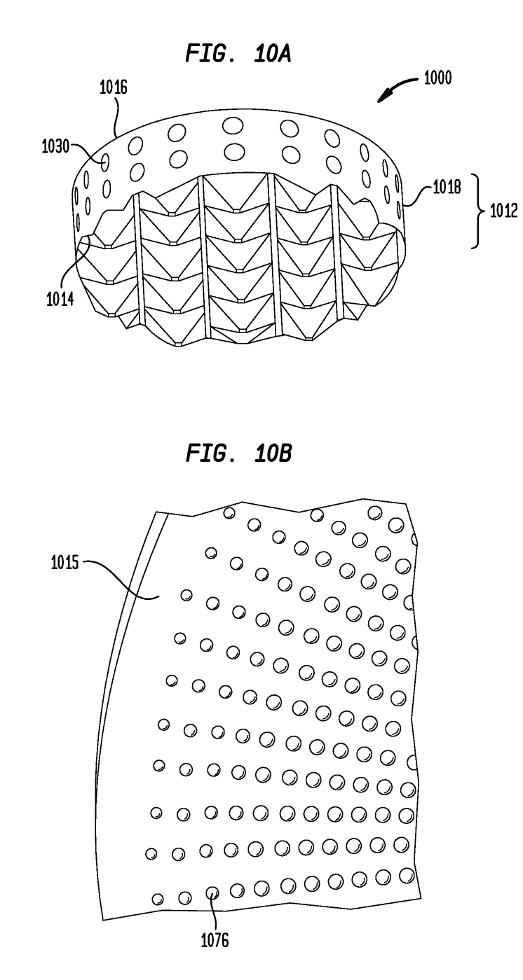

FIGS. 3A-8 primarily illustrates embodiments in which the body of an osteoconductive implantable component has a porous structure to facilitate bone ingrowth and/or ongrowth so as to interlock the implantable component with the recipient's skull bone. In the above embodiments, the bottom (i.e., bone-facing) surface has the same structure as the rest of the implantable component (i.e., generally porous). In alternative embodiments, the body and bottom surface of an osteoconductive implantable component may have different structures/arrangements. FIGS. 9A-10D illustrate embodiments in which a bottom surface may include one or more surface features.

For example, FIGS. 9A and 9B illustrate an embodiment in which the bottom surface of an osteoconductive implantable component 900 includes a plurality of surface features configured to promote osteoconduction, while the body of the implantable component is generally solid. FIG. 9A is a side view of the osteoconductive implantable component 900, while FIG. 9B is a lower-perspective view of a portion of the bottom surface of the osteoconductive implantable component 900.

As shown, the osteoconductive implantable component 900 comprises a body 912 formed by a bottom surface 914, a top surface 916, and a lateral surface 918 connecting the bottom surface 914 to the top surface 916. The body 912 has a generally rectangular shape where the lateral surface 918 generally has four sides connected by rounded corners. The rectangular shape of body 912 is merely illustrative and other shapes are possible.

Extending from top surface 916 into the body 912 is a threaded aperture (not shown) that is configured to receive and mate with a threaded abutment. Integrated with surface 916 is a generally frustoconical member 936 having an opening (not shown) therein in which a portion of a threaded abutment may be disposed.

Extending from bottom surface 916 are a plurality of protrusions 966. The protrusions 966 are each separated from one another and have tapered ends 967 configured to be positioned abutting a recipient's skull bone. The protrusions 966 also each include one or more transverse grooves 968 that extend substantially parallel to the bottom surface 914 of the body 912. When implanted abutting a recipient's skull bone, the protrusions 966 are configured to promote bone growth in a direction that is substantially perpendicular to a surface the recipient's skull (i.e., between the protrusions 966) and in a direction substantially parallel (i.e., non-perpendicular) to the surface of the recipient's skull (i.e., into the grooves 968). As such, after a bone growth period, portions of one or more of the plurality of the protrusions 966 are disposed between the non-perpendicular bone growth and the surface of the recipient's skull. In general, the protrusions 966 encourage bone growth that interlocks the osteoconductive implantable component 900 with the recipient's bone so as to prevent movement of the implantable component with respect to the recipient's skull.

As shown in FIG. 9B, the protrusions 966 are arranged into a plurality of rows. It is to be appreciated that the row arrangement of FIG. 9B is illustrative and that other arrangements for protrusions are possible. It also to be appreciated that the shapes of protrusions 966 of FIGS. 9A-9B are also illustrative and other shapes that promote interlocking of the bone with an implantable component are possible.

As noted, the body 912 of FIGS. 9A and 9B is generally solid. In further embodiments, osteoconductive surface features, such as protrusions 966, may be used in combination with a porous-solid scaffold as described above with reference to FIGS. 3A-8.

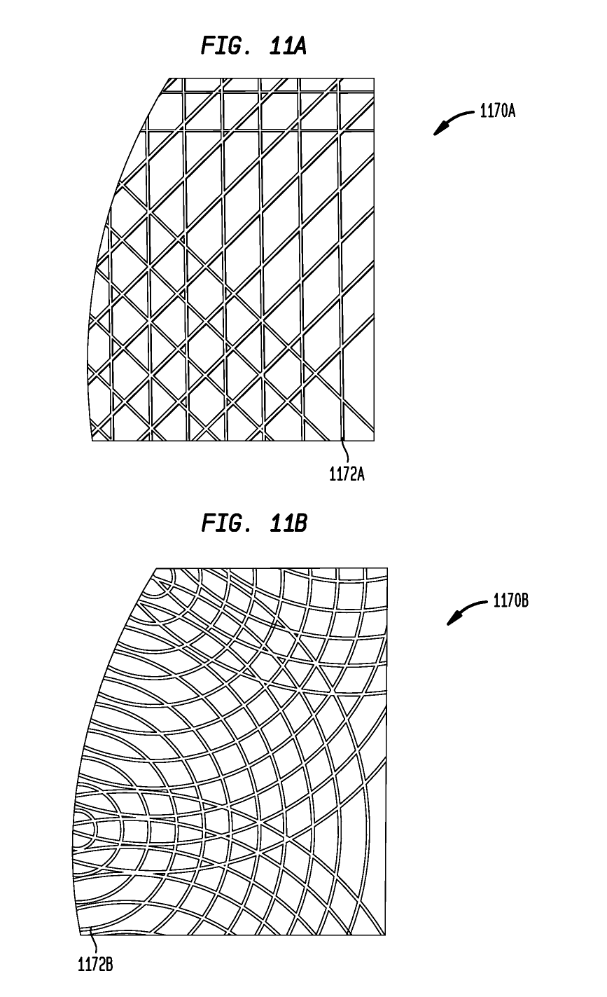

FIGS. 10A, 10B, 11A, and 11B illustrate further surface features that may be formed at a bottom surface of an implantable component. In general, the surface features shown in FIGS. 10A-10D are configured to promote osseointegration of an implantable component with a recipient's skull bone. As used herein, osseointegration generally refers to the anchorage of an implantable component to a recipient's bone by the formation of bony tissue around portions of a component. Although osteoconduction and osseointegration are related, osseointegration does not necessarily include the growth of tissue into portions of an implantable component.

FIG. 10A illustrates a lower-perspective view of a bottom surface 1014 of an osteoconductive implantable component 1000. As shown, the osteoconductive implantable component 1000 comprises a body 1012 formed by a bottom surface 1014, a top surface 1016, and a lateral surface 1018 connecting the bottom surface 1014 to the top surface 1016. The body 1012 has a generally flat-circular (disc) shape within a plurality of pores 1030.

In the example of FIG. 10A, a plurality of protrusions 1066 extend from the bottom surface 1014. The protrusions of FIG. 10 have a generally pyramidal shape. When implanted abutting a recipient's skull bone, the protrusions 1066 are configured to promote bone growth in a direction that is substantially perpendicular to a surface of the recipient's skull (i.e., between the protrusions 1066). As such, the recipient's skull bone grows around the protrusions 1066.

As noted, the protrusions 1066 of FIG. 10A have a generally pyramidal shape. It is to be appreciated that the pyramidal shape of FIG. 10A is merely illustrative and that other shapes are possible. For example, FIG. 10B illustrates an arrangement in which a plurality of rounded or dome-shaped protrusions 1076 extend from a bottom surface 1015 of an implantable component.

It is to be appreciated that the protrusions shown in FIGS. 10A and 10B may be used in combination with a porous scaffold as described above with reference to FIGS. 3A-8. In certain such embodiments, a bottom surface may include both osteoconductive pores (as described above) and protrusions as describe above with reference to FIGS. 10A-10B.

FIGS. 11A and 11B illustrate further embodiments in which the surface features comprise a pattern of grooves disposed in a bottom surface of an implantable component. For ease of illustration, FIGS. 11A and 11B illustrate portions of bottom surfaces 1114A and 1114B, respectively of an implantable component.

FIG. 11A illustrates a pattern 1170A of intersecting linear grooves 1172A (i.e., grooves formed as straight lines). FIG. 11B illustrates a pattern 1170B of intersection curved grooves 1172B (i.e., grooves formed as curved lines). The grooves 1172A or 1172B may have a depth in the range of approximately 50 μm to approximately 200 μm and a width in the range of approximately 70 μm to approximately 350 μm. The shape of the grooves 1172A or 1172B can be wedge shaped (with or without a bottom radius), u-shaped with a bottom radius and straight sides, etc.

In the embodiments of FIGS. 11A and 11B, the grooves 1172A and 1172B, respectively, are configured to promote bone growth in a direction that is substantially perpendicular to a surface of the recipient's skull. As such, the recipient's skull bone grows around sections of the bottom surfaces 1114A and 1114B between grooves 1172A and 1172B, respectively.

In certain embodiments of FIGS. 11A and 11B, one or more of the grooves 1172A and/or 1172B include portions that, when the implantable component is implanted, are substantially parallel to a surface of the recipient's skull to promote bone growth in a direction that is substantially parallel to the surface of the recipient's skull. In other embodiments, or more of the grooves 1172A and/or 1172B include portions that, when the implantable component is implanted, are positioned at an angle relative to a surface of the recipient's skull to promote bone growth at an angle relative to the surface of the recipient's skull.

It is to be appreciated that the grooves shown in FIGS. 11A and 11B may be used in combination with a porous scaffold as described above with reference to FIGS. 3A-8. In certain such embodiments, the bottom surfaces 1114A and 1114B may include both osteoconductive pores (as described above) and grooves as describe above with reference to FIGS. 11A-11B.

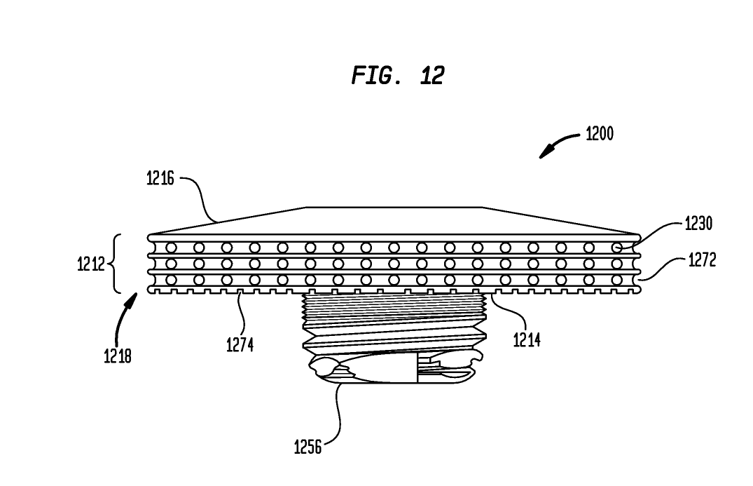

FIG. 12 illustrates a further embodiment of an osteoconductive implantable component 1200 that includes grooves. As shown, the osteoconductive implantable component 1200 comprises a body 1212 formed by a bottom surface 1214, a top surface 1216, and a lateral surface 1218 connecting the bottom surface 1214 to the top surface 1216. The body 1212 has a generally flat-circular (disc) shape.

In the embodiment of FIG. 12, a bone screw 1256 is integrated with body 1212 and extends from bottom surface 1214 and a plurality of grooves 1274 are formed into the bottom surface 1214 around the bone screw 1256. Additionally, a plurality of grooves 1272 are disposed in the lateral surface 1218. The grooves 1272 and 1274 may have a depth in the range of approximately 50 μm to approximately 200 μm and a width in the range of approximately 70 μm to approximately 350 μm. The shape of the grooves 1272 or 1272 can be wedge shaped (with or without a bottom radius), u-shaped with a bottom radius and straight sides, etc. The grooves 1272 and 1274 may have the same or different arrangements.

As shown in FIG. 12, a plurality of pores 1230 is disposed in the grooves 1272 into the body 1212. Similar pores 1230 may be disposed in the grooves 1274. The pores 1230 are inlets for channels (not shown) that extend (partially or fully) through the main portion of body 1212. As such, body 1212 is a porous-solid scaffold comprising a regular three-dimensional array of struts that is configured to promote osteoconduction with a recipient's skull bone. In alternative embodiments, the pores 1230 may be disposed in the lateral surface 1218 and bottom surface 1214 at locations between grooves 1230.

The invention described and claimed herein is not to be limited in scope by the specific preferred embodiments herein disclosed, since these embodiments are intended as illustrations, and not limitations, of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

What is claimed is:

1. An implantable component configured to couple an external bone conduction device to a recipient, comprising:
an osteoconductive body comprising a first surface configured to be positioned substantially parallel to and abutting a surface of the recipient's skull, a second surface opposing the first surface, and a lateral surface connecting the first and second surfaces,
wherein the body is a porous-solid scaffold configured to promote growth of the recipient's skull bone in a manner that interlocks the osteoconductive body with the recipient's skull.

2. The implantable component of claim 1, wherein the body is a trabecular structure comprising an irregular three-dimensional array of struts.

3. The implantable component of claim 1, wherein the body is an organized mesh structure comprising a regular three-dimensional array of struts.

4. The implantable component of claim 1, wherein the body is configured to promote bone growth from the recipient's skull in a direction substantially perpendicular to the surface of the recipient's skull abutting the first surface and in a direction substantially parallel to the surface of the recipient's skull abutting the first surface.

5. The implantable component of claim 1, wherein the first surface and the lateral surface comprise a plurality of pores.

6. The implantable component of claim 5, wherein the pores have diameters in the arrange of approximately 0.2 millimeters (mm) to approximately 0.8 mm

7. The implantable component of claim 1, wherein the first surface of the implantable component comprises a pattern of grooves.

8. The implantable component of claim 7, wherein the grooves have a depth in the range of approximately 50 micrometers (μm) to approximately 200 μm and a width in the range of approximately 70 μm to approximately 350 μm.

9. The implantable component of claim 1, wherein the first surface comprises a plurality of protrusions each comprising one or more transverse grooves that when the implantable component is implanted, are substantially parallel to the surface of the recipient's skull abutting the first surface.

10. The implantable component of claim 1, further comprising:
an aperture extending from the second surface into the body, wherein the aperture is configured to mate with an external abutment.

11. The implantable component of claim 1, further comprising:
a magnetic component disposed in the body configured to magnetically couple to an external component of a bone conduction device.

12. The implantable component of claim 1, further comprising:
one or more through-holes configured to receive a bone screw configured to attach the implantable component to the recipient's skull.

13. The implantable component of claim 1, further comprising:
a coating disposed on the body and configured to promote osseointegration

14. The implantable component of claim 13, wherein the coating is a hydroxyapatite coating.

15. An implantable component configured to couple an external element to a recipient, comprising:
a body comprising a first surface configured to be positioned substantially parallel to and abutting a surface of the recipient's skull, a second surface opposing the first surface, and a lateral surface connecting the first and second surfaces; and
a plurality of features configured to promote bone growth from the surface of the recipient's skull in a manner such that the bone growth interlocks with the plurality features so as to prevent movement of the implantable component with respect to the recipient's skull.

16. The implantable component of claim 15, wherein the plurality of features are configured to promote bone growth in a direction that is non-perpendicular to the surface of the recipient's skull such that after a bone growth period portions of one or more of the plurality of features are configured to be disposed between the non-perpendicular bone growth and the surface of the recipient's skull.

17. The implantable component of claim 15, further comprising:
a plurality of features having shapes configured to promote bone growth from the surface of the recipient's skull in a direction substantially perpendicular to the surface of the recipient's skull abutting the first surface and in a direction substantially parallel to the surface of the recipient's skull abutting the first surface.

18. The implantable component of claim 15, wherein at least a portion of the plurality of features are disposed on the first surface.

19. The implantable component of claim 15, wherein at least a portion of the plurality of features are disposed in the body.

20. The implantable component of claim 15, wherein the body is a trabecular structure comprising an irregular three-dimensional array of struts.

21. The implantable component of claim 15, wherein the body is an organized mesh structure comprising a regular three-dimensional array of struts.

22. The implantable component of claim 15, wherein one or more of the first surface and the lateral surface comprises a pattern of grooves forming at least a portion of the plurality of features.

23. The implantable component of claim 22, wherein one or more grooves in the pattern of grooves include portions that, when the implantable component is implanted, are substantially parallel to the surface of the recipient's skull abutting the first surface.

24. The implantable component of claim 15, further comprising:
an aperture extending from the second surface into the body, wherein the aperture is configured to mate with an external abutment.

25. The implantable component of claim 15, further comprising:
a magnetic component disposed in the body configured to magnetically couple to an external component of a bone conduction device.

26. The implantable component of claim 15, further comprising:
one or more through-holes configured to receive a bone screw configured to attach the implantable component to the recipient's skull.

27. The implantable component of claim 15, further comprising:
a coating disposed on the body and configured to promote osseointegration.

28. The implantable component of claim 27, wherein the coating is a hydroxyapatite coating.
